(19) United States
(12) Patent Application Publication
(10) Pub. No.: US 2023/0092785 A1
(43) Pub. Date: Mar. 23, 2023

(54) CELL-TO-CELL BUSBAR FUSE

(71) Applicant: Apple Inc., Cupertino, CA (US)

(72) Inventors: Abraham Bruno Caulk, Livermore, CA (US); Dylan Charles Erb, San Jose, CA (US); Paul W. Firehammer, West Olive, MI (US)

(21) Appl. No.: 17/739,962

(22) Filed: May 9, 2022

Related U.S. Application Data
(60) Provisional application No. 63/247,521, filed on Sep. 23, 2021.

(51) Int. Cl. H01M 50/514; H01M 50/503; H01M 50/204; H01M 50/543

(52) U.S. Cl. CPC H01M 50/514; H01M 50/503; H01M 50/204; H01M 50/543; H01M 2200/103

(57) ABSTRACT

A busbar for a battery module includes a first portion configured to be coupled to a first terminal of a first battery cell, a second portion configured to be coupled to a second terminal of a second battery cell, and a fuse portion extending between the first portion and the second portion. The fuse portion includes a number of openings extending through the fuse portion. Each pair of openings defines an electrical path between the first portion of the busbar and the second portion of the busbar.

### CROSS-REFERENCE TO RELATED APPLICATIONS

This application claims priority to U.S. Provisional Application No. 63/247,521, entitled “CELL-TO-CELL BUSBAR FUSE,” filed Sep. 23, 2021, the disclosure of which is incorporated by reference in its entirety for all purposes.

### BACKGROUND

The present disclosure relates generally to a battery module, and, more specifically, to a fuse of the battery module.

A battery module may include a number of electrochemical cells, such as lithium-ion cells, coupled via an electrical path to generate a charge having a particular voltage and current for powering a load. For example, the electrical path may couple terminals of the electrochemical cells in series such that individual voltages of the electrochemical cells are combined to generate a total voltage of the charge, or in parallel such that individual currents of the electrochemical cells are combined to generate a total current of the charge. In some embodiments, series and parallel couplings are employed between various electrochemical cells of the battery module to generate a total voltage and total current compatible with the load receiving the charge.

In certain operating conditions and/or during assembly of the battery module, the battery module may be susceptible to an arc fault occurring in or around the electrical path, which can produce an arc flash. In general, “arc fault” refers to a relatively high power discharge of electricity between two or more conductors. For example, an arc fault may occur when an electric current increases beyond normal operating conditions and exceeds an electric current threshold. “Arc flash” refers to undesirable heat and light produced by the arc fault as the electricity is discharged from the electrical path, through air, and to ground or another voltage phase of the battery module. Arc faults may occur due to corrosion, buildup of conductive dusts, intermittent contact between loose fitting components of the electrical path, inadvertent contact between the electrical path and a tool or component that is not a part of the electrical path, and other conditions.

In an effort to reduce arc flash associated with an arc fault, traditional battery modules may employ a fuse within the electrical path, where the fuse is configured to melt in response to the electric current exceeding an electric current threshold (or a temperature produced by the electric current exceeding a threshold temperature). However, a traditional fuse may contribute to a size of the battery module, thereby reducing an energy density of the battery module. Further, arc fault conditions may occur in areas of the electrical path away from the traditional fuse. Further still, melting of the traditional fuse may cause permanent negative effects to the battery module, permanently disable the battery module, and/or require extensive maintenance on the battery module.

Additionally, personnel that assemble traditional battery modules may be required to don personal protective equipment (PPE) based on certain regulatory standards relating to arc flash. An amount or extent of PPE required by the regulatory standards is generally dependent on an amount of arc flash that could occur during assembly of the battery module. Certain traditional fuses, for example, may allow for a relatively large electric current (or amount of arc flash) before melting and disrupting the circuit, thereby requiring a relatively large amount of PPE.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment of the present disclosure, a busbar for a battery module includes a first portion configured to be coupled to a first terminal of a first battery cell, a second portion configured to be coupled to a second terminal of a second battery cell, and a fuse portion extending between the first portion and the second portion. The fuse portion includes a number of openings extending through the fuse portion. Each pair of openings defines an electrical path between the first portion of the busbar and the second portion of the busbar.

In another embodiment of the present disclosure, a battery module includes a first electrochemical cell having a first terminal, a second electrochemical cell having a second terminal, and a busbar. The bubar includes a first portion coupled to the first terminal of the first electrochemical cell, a second portion coupled to the second terminal of the second electrochemical cell, and a zipper fuse extending between the first portion and the second portion.

In another embodiment of the present disclosure, a method of manufacturing a battery module includes coupling a first portion of a busbar with a first terminal of a first electrochemical cell, and coupling a second portion of the busbar with a second terminal of a second electrochemical cell, such that an electrical path is defined between the first terminal and the second terminal by the first portion of the busbar, the second portion of the busbar, and a fuse portion of the busbar extending between the first portion and the second portion.

In another embodiment of the present disclosure, a busbar for a battery module includes a first portion configured to be coupled to a first terminal of a first electrochemical cell, a second portion configured to be coupled to a second terminal of a second electrochemical cell, and a fuse portion extending between the first portion and the second portion. The fuse portion includes a zipper fuse having electrical paths configured to generate corresponding electrical resistances, each electrical resistance of the electrical resistances being different than the other electrical resistances of the electrical resistances.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electrical system including a load and a battery module having a busbar fuse, according to embodiments of the present disclosure;

FIG. 2 is a schematic side view of the battery module of FIG. 1 having multiple busbar fuses, according to embodiments of the present disclosure;

FIG. 3 is a schematic cross-sectional front view of the battery module of FIG. 2, taken along line 3-3 in FIG. 2, and including a busbar fuse, according to embodiments of the present disclosure;

FIG. 4 is a schematic perspective view of a busbar fuse coupling a first electrochemical cell and a second electrochemical cell of the battery module of FIG. 2, according to embodiments of the present disclosure;

FIG. 5 is a graph illustrating an arc flash current in amperes (Y-axis) versus an electrochemical cell series count (X-axis) of the battery module of FIG. 2, according to embodiments of the present disclosure;

FIG. 6 is a perspective view of a busbar fuse of the battery module of FIG. 2, according to embodiments of the present disclosure;

FIG. 7 is a front view of a busbar fuse of the battery module of FIG. 2, where the busbar fuse is in a melted state after having received an electric current exceeding an electric current threshold, according to embodiments of the present disclosure;

FIG. 8 is a front view of a busbar fuse of the battery module of FIG. 2, where the busbar fuse receives an electric current exceeding an electric current threshold, according to embodiments of the present disclosure;

FIG. 9 is a front view of the busbar fuse of FIG. 8, where the busbar fuse is beginning to melt in response to receiving the electric current exceeding the electric current threshold, according to embodiments of the present disclosure;

FIG. 10 is a front view of the busbar fuse of FIG. 8, where the busbar fuse continues to melt in response to receiving the electric current exceeding the electric current threshold, according to embodiments of the present disclosure;

FIG. 11 is a front view of the busbar fuse of FIG. 8, where the busbar fuse is in a melted state after having received the electric current exceeding the electric current threshold, according to embodiments of the present disclosure;

FIG. 12 is a front view of a busbar fuse of the battery module of FIG. 2 and having a fuse portion with circular openings, according to embodiments of the present disclosure;

FIG. 13 is a front view of a busbar fuse of the battery module of FIG. 2 and having a fuse portion with slot-shaped and circular openings, according to embodiments of the present disclosure;

FIG. 14 is a front view of a busbar fuse of the battery module of FIG. 2 and having a fuse portion with slot-shaped openings, according to embodiments of the present disclosure;

FIG. 15 is a schematic side view of a busbar fuse pre-stressing technique for the battery module of FIG. 2 based on translation of a first electrochemical cell relative to a second electrochemical cell along a height direction, according to embodiments of the present disclosure;

FIG. 16 is a schematic side view of a busbar fuse pre-stressing technique for the battery module of FIG. 2 based on translation of a first electrochemical cell relative to a second electrochemical cell along a length or width direction, according to embodiments of the present disclosure;

FIG. 17 is a schematic side view of a busbar fuse pre-stressing technique for the battery module of FIG. 2 based on translation of a first terminal of a first electrochemical cell relative to a second terminal of a second electrochemical cell along a length or width direction, according to embodiments of the present disclosure; and

FIG. 18 is a process flow diagram illustrating a method of manufacturing the battery module of FIG. 2, according to embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on).

This disclosure is directed to a battery module having a busbar fuse. The busbar fuse includes a fuse portion having a relatively small thickness and a number of openings extending there through, where electrical paths are defined between various pairs of the openings. As described in detail below, the thickness, the openings, and the electrical paths are designed to cause the fuse portion to melt in response to an electric current through the busbar fuse at or approaching arc fault conditions (e.g., the electric current exceeding an electric current threshold).

In accordance with the present disclosure, a battery module includes electrochemical cells coupled via a main electrical path to generate a charge having a particular voltage and a particular current compatible with a load receiving the charge. The load may include, for example, a personal computer, a mobile communication device (e.g., a laptop, a tablet, a cellphone, a wearable device), a vehicle (e.g., a car, a truck, a train, a boat, a motorcycle), a digital camera, a video game device, home maintenance tools (e.g., a drill, a lawn mower, a blower), or any other battery-powered electronic device. The electrochemical cells may include, for example, lithium-ion (Li-ion) cells, nickel-metal hydride (NiMH) cells, nickel-cadmium (NiCd) cells, lead-acid cells, or another type of rechargeable, secondary electrochemical cells.

The main electrical path referenced above may include a number of busbars configured to couple terminals of the electrochemical cells in series such that individual voltages of the electrochemical cells are combined to generate a total voltage of the charge, or in parallel such that individual currents of the electrochemical cells are combined to generate a total current of the charge. In some embodiments, both series and parallel couplings are employed between various electrochemical cells of the battery module to generate a total voltage and total current compatible with a particular load receiving the charge.

In certain operating conditions and/or during assembly of the battery module, the battery module may be susceptible to an arc fault occurring in or around the main electrical path. In general, “arc fault” refers to a relatively high power discharge of electricity between two or more conductors. “Arc flash” refers to undesirable heat and light produced by the arc fault as the electricity is discharged from the electrical path, through air, and to ground or another voltage phase of the battery module. Arc faults may occur, for example, due to corrosion, buildup of conductive dusts, intermittent contact between loose fitting components of the main electrical path, inadvertent contact between the main electrical path and a tool or component that is not a part of the main electrical path, and any other condition that causes a relatively high electric current through the main electrical path.

In accordance with the present disclosure, the battery module includes one or more busbar fuses configured to melt in response to a relatively high electric current to create an open circuit that reduces or prevents the arc flash. Each busbar fuse includes a first portion configured to contact a first terminal of a first electrochemical cell of the battery module, a second portion configured to contact a second terminal of a second electrochemical cell of the battery module, and a fuse portion extending between the first portion and the second portion. The fuse portion is configured to melt, for example, in response to an electric current in the busbar fuse exceeding a threshold electric current. The busbar fuse may include various characteristics (e.g., sizes and geometries of various portions of the busbar fuse) described in detail below that are configured to cause certain resistances within the fuse portion, where the resistances are utilized to control melting of the fuse portion in response to a relatively high electric current.

For example, the fuse portion may include a thickness that is less than a first thickness of the first portion and a second thickness of the second portion. Further, the fuse portion may include a number of openings through the thickness of the fuse portion. Each pair of openings through the fuse portion may define a respective electrical path therebetween. That is, a number of electrical paths through the fuse portion may reside within the main electrical path of the battery module. The electrical paths may be configured (e.g., sized, located) such that an electrical resistance of each electrical path differs from the electrical resistance of the other electrical paths. In this way, a current density through the various electrical paths may differ, causing the fuse portion to melt in response to the relatively high electric current in a controlled manner. In one embodiment, the electrical paths may begin to melt in an ordered arrangement from one side of the fuse portion to the other. For these reasons, among others, the fuse portion including the arrangement of the openings and corresponding electrical paths may be referred to as a zipper fuse or zipper arrangement. As the fuse portion receives the relatively high electric current, the fuse portion may be heated and ultimately melt, thereby disconnecting the first electrochemical cell from the second electrochemical cell and reducing or negating an arc flash associated with an arc fault.

By including the busbar fuse in accordance with the present disclosure, the battery module may be safely assembled and operated without a dedicated fuse separate from the busbar fuse, thereby reducing a size and improving an energy density of the battery module relative to traditional embodiments. Indeed, any number of busbar fuses may be employed without substantially contributing to the size of the battery module (as the busbar fuses may take the place of conventional busbars), thereby providing arc fault interruption throughout various portions of the main electrical path of the battery module. Further, negative effects associated with melting of the fuse portion may be limited to the busbar fuse, thereby reducing or negating negative effects to other components of the battery module, such as the electrochemical cells and terminals thereof. Further still, the presently disclosed busbar fuse may reduce an amount of personal protective equipment (PPE) required for personnel assembling the battery module.

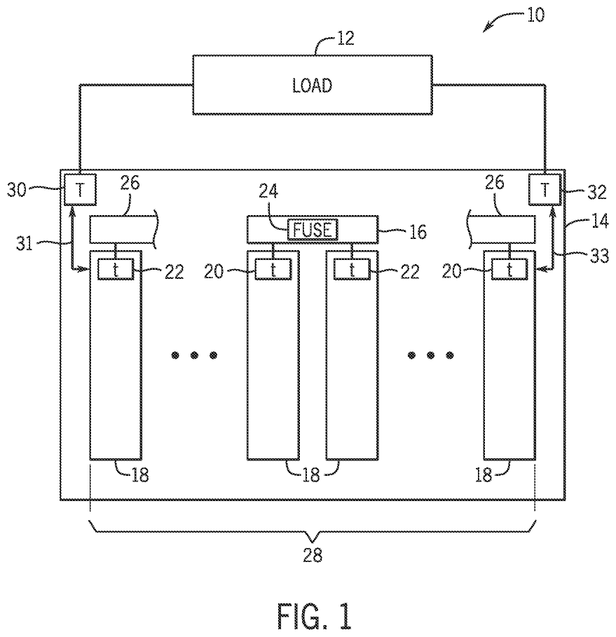

With the foregoing in mind, FIG. 1 is a block diagram of an embodiment of an electrical system 10 including a load 12 and a battery module 14, where the battery module 14 includes a busbar fuse 16. The load 12 may include, for example, a personal computer, a mobile communication device (e.g., a laptop, a tablet, a cellphone, a wearable device), a vehicle (e.g., a car, a truck, a train, a boat, a motorcycle), a digital camera, a video game device, home maintenance tools (e.g., a drill, a lawn mower, a blower), or any other battery-powered device. The battery module 14 includes a number of electrochemical cells 18 electrically coupled to produce a charge for powering the load 12, the charge having a total voltage and total current compatible with the load 12. In general, the electrochemical cells 18 may be electrically coupled in series such that individual voltages of the electrochemical cells 18 are combined to generate a total voltage of the charge, or in parallel such that individual currents of the electrochemical cells 18 are combined to generate a total current of the charge. In some embodiments, series and parallel couplings are employed across various ones of the electrochemical cells 18 based on the desired total voltage and total current of the charge for powering the load 12.

Each electrochemical cell 18 of the battery module 14 includes a first terminal 20 (e.g., positive terminal) and a second terminal 22 (e.g., negative terminal). For simplicity, only one of the first terminal 20 or the second terminal 22 for each electrochemical cell 18 is shown in FIG. 1, but it should be understood that each electrochemical cell 18 also includes the other of the first terminal 20 or the second terminal 22 (e.g., hidden from view in the illustrated perspective). In the illustrated embodiment, the busbar fuse 16 couples the first terminal 20 of a first electrochemical cell 18 with the second terminal 22 of a second electrochemical cell 18 (e.g., in series). The busbar fuse 16 includes a fuse portion 24 designed to melt in response to receiving an electric current that is at or approaches arc fault conditions (e.g., relatively high power and/or temperature), as described in detail below. Other busbars 26 (e.g., not including the fuse portion 24 of the busbar fuse 16) may also be employed to couple the terminals 20, 22 of adjacent electrochemical cells 18. It should be noted that multiple instances of the busbar fuse 16 may be employed in the battery module 14. Further, the busbar fuse 16 and the other busbars 26 may include an electrically conductive material, such as aluminum, aluminum alloys (e.g., 1000 series aluminum alloys or 6061 aluminum alloy), copper, copper/aluminum laminates, laminated flexible aluminum, or the like. The busbar(s) 26, busbar fuse(s) 16, and electrochemical cells 18 are referred to in certain instances below as a group 28 of interconnected electrochemical cells 18.

The group 28 of interconnected electrochemical cells 18 is coupled to a first major terminal 30 (e.g., positive major terminal) of the battery module 14 via a first major busbar 31. The group 28 of interconnected electrochemical cells 18 is also coupled to a second major terminal 32 (e.g., negative major terminal) of the battery module 14 via a second major busbar 33. The first major terminal 30 and the second major terminal 32 are coupled to the load 12 such that the charge generated by the group 28 of interconnected electrochemical cells 18 of the battery module 14 powers the load 12.

As previously described, the busbar fuse 16 includes the fuse portion 24 configured to melt in response to a relatively high electric current through the busbar fuse 16. For example, the fuse portion 24 may include a thickness that is less than other portions of the busbar fuse 16. Further, the busbar fuse 16 may include openings extending through the fuse portion 24 of the busbar fuse 16, with electrical paths being defined between pairs of the openings through the fuse portion 24. In this way, the electrical paths through the fuse portion 24 may reside within a main electrical path of the battery module 14 defined by the group 28 of interconnected electrochemical cells 18. The busbar fuse 16 may be configured such that the electrical paths defined by the openings through the fuse portion 24 melt in a particular manner or order that disrupts the arc fault and reduces an amount of arc flash current associated with the arc fault. As previously described, the busbar fuse 16 having the fuse portion 24 may reduce a size or footprint of the battery module 14 relative to traditional embodiments of fuses, provide arc fault interruption in more areas of the battery module 14 than traditional embodiments, limit negative effects associated with arc fault conditions to the busbar fuse 16 (e.g., as opposed to other components of the battery module 14), and reduce an amount of personal protective equipment (PPE) required for personnel assembling the battery module 14 relative to traditional embodiments.

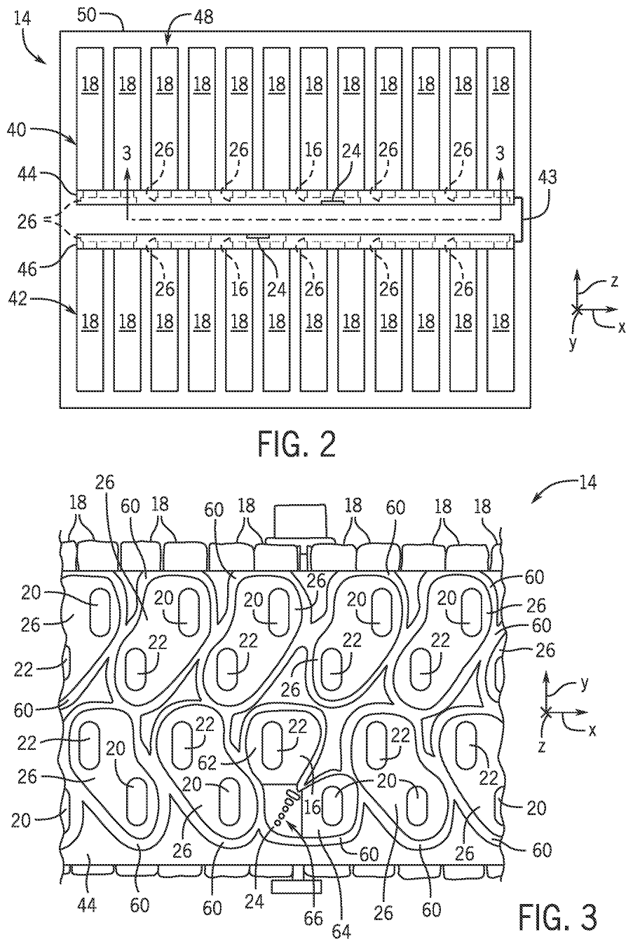

FIG. 2 is a schematic side view of an embodiment of the battery module 14 of FIG. 1, having multiple instances of the busbar fuse 16. In the illustrated embodiment, the battery module 14 includes a first row 40 of the electrochemical cells 18 and a second row 42 of the electrochemical cells 18. The first row 40 and the second row 42 may be coupled in series or in parallel via an intermediate busbar 43. In the illustrated embodiment, a first instance of the busbar fuse 16 is employed to couple two electrochemical cells 18 in the first row 40, and a second instance of the busbar fuse 16 is employed to couple two other electrochemical cells 18 in the second row 42. However, any number of instances of the busbar fuse 16 may be employed. A number of busbars 26 (i.e., not having the fuse portion 24 of the busbar fuse 16) may also be employed to electrically couple various electrochemical cells 18 of the battery module 14.

A first tray 44 of the battery module 14 includes receptacles that receive the busbars 26 and the busbar fuses 16 associated with the first row 40. The first tray 44 also includes openings that receive terminals of the electrochemical cells 18 of the first row 40 to enable contact between the terminals and the busbars 26 and/or the busbar fuses 16. A second tray 46 of the battery module 14 includes receptacles that receive the busbars 26 and the busbar fuses 16 associated with the second row 42. The second tray 46 also includes openings that receive terminals of the electrochemical cells 18 of the second row 42 to enable contact between the terminals and the busbars 26 and/or busbar fuses 16. The electrochemical cells 18, busbars 26, busbar fuses 16, trays 44, 46, and other components of the battery module 14 may be disposed in an interior 48 of a battery module housing 50. It should be noted that any number of the rows and trays may be employed and disposed in the interior 48 of the battery module housing 50. Further, while the first row 40 includes a single tray 44 and the second row 42 includes a single tray 46 in the illustrated embodiment, each row 40, 42 may include multiple dedicated trays.

FIG. 3 is a schematic cross-sectional front view of an embodiment of the battery module 14 of FIG. 2, taken along line 3-3 in FIG. 2, including the busbar fuse 16. In the illustrated embodiment, each of the electrochemical cells 18 includes one first terminal 20 and one second terminal 22. As previously described, each of the busbars 26 and the busbar fuse 16 are employed to couple the first terminal 20 of a respective first electrochemical cell 18 with the second terminal 22 of a respective second electrochemical cell 18. The tray 44 includes receptacles 60 configured to receive the busbars 26 and the busbar fuse 16. The tray 44 also includes openings through which the terminals 20, 22 of the electrochemical cells 18 extend into the receptacles 60 for contacting the corresponding busbar 26 or busbar fuse 16. The tray 44 may be injection molded from a material that is insulative (e.g., not electrically conductive), such as a thermoplastic polymer material.

The busbar fuse 16 includes a first portion 62 coupled to the second terminal 22 of a first electrochemical cell 18, a second portion 64 coupled to the first terminal 20 of a second electrochemical cell 18, and the fuse portion 24 extending between the first portion 62 and the second portion 64 of the busbar fuse 16. The fuse portion 24 is configured to melt in response to receiving an electric current that exceeds an electric current threshold.

For example, the fuse portion 24 in the illustrated embodiment may include a thickness that is less than a first thickness of the first portion 62 of the busbar fuse 16 and less than a second thickness of the second portion 64 of the busbar fuse 16. The fuse portion 24 may also include openings 66 arranged in a line through the fuse portion 24, referred to in certain instances of the present disclosure as a zipper fuse or zipper arrangement. Pairs of the openings 66 may define a respective electrical path through the fuse portion 24 and between the first portion 62 and the second portion 64. The relative thickness of the fuse portion 24, the openings 66, and the respective electrical paths defined by the openings 66 may cause the fuse portion 24 to melt in response to relatively high electric currents and/or temperatures.

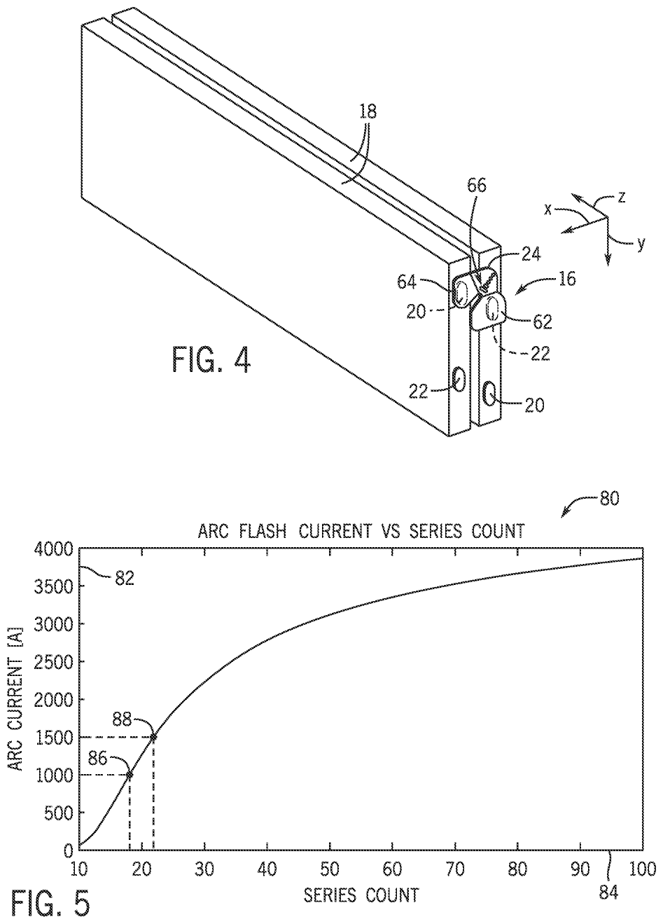

For purposes of clarity, FIG. 4 illustrates a schematic perspective view of an embodiment of the busbar fuse 16 coupling a first electrochemical cell 18 and a second electrochemical cell 18 of the battery module 14, but without the tray 44 included in FIG. 3. The busbar fuse 16 in the illustrated embodiment includes the same or similar features noted above with respect to FIG. 3, including the first portion 62 coupled to the second terminal 22 of a first electrochemical cell 18, the second portion 64 coupled to the first terminal 20 of a second electrochemical cell 18, the fuse portion 24 extending between the first portion 62 and the second portion 64, and the openings 66 extending through the fuse portion 24. Detailed description of the openings and corresponding electrical paths (and corresponding functionality) will be described in greater detail with reference to later drawings. In the illustrated embodiment, the electrochemical cells 18 are prismatic electrochemical cells 18. However, it should be noted that, in another embodiment, the electrochemical cells 18 may include pouch cells, cylindrical cells, or other types of electrochemical cells.

As previously described, any number of the busbar fuses 16 may be included in the battery module 14. In general, including more instances of the busbar fuse 16 in the battery module 14 (as opposed to the busbars 26 without the fuse portion 24) may reduce an amount of arc flash that occurs during an arc fault within the battery module 14. Indeed, the electric current passing through the electrical path of the battery module 14 may have increasingly shorter paths of travel before reaching a busbar fuse 16 as the number of busbar fuses 16 employed in the battery module 14 increases. In other words, reducing a number of the electrochemical cells 18 between fused locations of the battery module 14 may reduce or negate an amount of arc flash that occurs during an arc fault.

FIG. 5 is an embodiment of a graph 80 illustrating an arc flash current in amperes (i.e., across a Y-axis 82 of the graph 80) versus an electrochemical cell series count of the electrochemical cells 18 (i.e., across an X-axis 84). As shown via a first data point 86 in the illustrated graph 80, the arc flash current during an arc fault is expected to be 1000 amperes if the electric current at issue passes through approximately 18 electrochemical cells 18 in series. As shown via a second data point 88 in the illustrated graph 80, the arc flash current during an arc fault is expected to be 1500 amperes if the electric current at issue passes through approximately 23 electrochemical cells 18 in series. Thus, the graph 80 indicates that including more instances of the busbar fuse 16 will reduce an amount of arc flash current associated an arc fault. Because the busbar fuse 16 in the present disclosure serves the purpose of a busbar and a fuse (e.g., as opposed to including a separate and dedicated fuse and a separate and dedicated busbar), including several instances of the busbar fuse 16 may not substantially increase a size of the battery module 14 and may provide improved arc fault interruption relative to traditional embodiments.

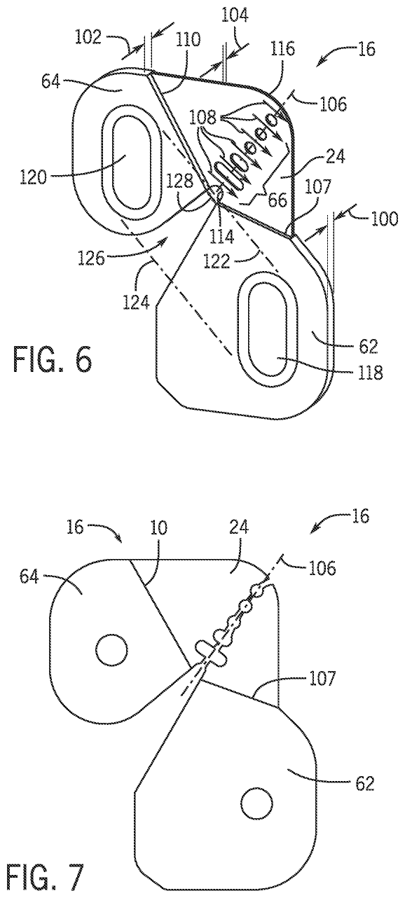

FIG. 6 is a perspective view of an embodiment of the busbar fuse 16 of the battery module 14 of FIG. 2. The busbar fuse 16 includes the first portion 62, the second portion 64, and the fuse portion 24 extending between the first portion 62 and the second portion 64. As previously described, the fuse portion 24 may include a relatively shallow thickness compared to the first portion 62 and the second portion 64 of the busbar fuse 16. For example, the first portion 62 includes a first thickness 100, the second portion 64 includes a second thickness 102, and the fuse portion 24 includes a third thickness 104 that is less than the first thickness 100 and less than the second thickness 102. The first thickness 100 and the second thickness 102 are the same in the illustrated embodiment, but may be different in another embodiment. As an example, the first thickness 100 may be two millimeters, the second thickness 102 may be two millimeters, and the third thickness 104 may be 0.5 millimeters. However, the size of the busbar fuse 16 may be scaled based on the size, energy density, or other characteristics of the battery module 14. In general, the third thickness 104 may be approximately 25% of the first thickness 100 and 25% of the second thickness 102. However, the relative dimensions of the thicknesses 100, 102, 104 may vary based on the intended electric current threshold of the busbar fuse 16. Thus, the third thickness 104 may be approximately 5-50% of the first thickness 100 and 5-50% of the second thickness 102.

The fuse portion 24 of the busbar fuse 16 is coupled to a first edge 107 of the first portion 62 of the busbar fuse 16 and a second edge 110 of the second portion 64 of the busbar fuse 16. Because of the thicknesses 100, 102, 104 of the first portion 62, the second portion 64, and the fuse portion 24, the fuse portion 24 and the first portion 62 of the busbar fuse 16 may form a stepped configuration at the first edge 107, and the fuse portion 24 and the second portion 64 of the busbar fuse 16 may form another stepped configuration at the second edge 110.

The fuse portion 24 of the busbar fuse 16 may also include the openings 66 extending through the fuse portion 24. The openings 66 may be arranged in a row centered on a fuse axis 106. The first edge 107 of the first portion 62 of the busbar fuse 16 and the second edge 110 of the second portion 64 of the busbar fuse 16 may extend at non-90 degree angles (e.g., acute angles) relative to the fuse axis 112. The fuse portion 24, and in particular the openings 66 of the fuse portion, may be offset from the first portion 62 and the second portion 64 of the busbar fuse 16. A number of electrical paths 108 through the fuse portion 24 are defined by pairs of the openings 66, one of the openings 66 and a U-shaped edge 114 of the fuse portion 24, and another of the openings 66 and a curvilinear outer edge 116 of the fuse portion 24. Two of the electrical paths 108 are also defined adjacent to the U-shaped edge 114 and the curvilinear outer edge 116. The fuse portion 24 having the openings 66 and the corresponding electrical paths 108, arranged in a row along the fuse axis 106, may be referred to as a zipper fuse or zipper arrangement.

In general, as the electric current through the fuse portion 24 increases and before melting occurs, a current density may be highest in the electrical path 108 extending adjacent the U-shaped edge 114 of the fuse portion 24, and the current density may be lowest in the electrical path 108 extending adjacent to the curvilinear outer edge 116. The current density may be greater adjacent the U-shaped edge 114 than adjacent the curvilinear outer edge 116 because a first distance between the portions 62, 64 of the busbar fuse 16 and through the electrical path 108 adjacent the U-shaped edge 114 is less than a second distance between the portions 62, 64 of the busbar fuse 16 and through the electrical path 108 adjacent the curvilinear outer edge 116. Indeed, a resistance faced by the electrical current adjacent the U-shaped edge 114 is, in total, less than a resistance faced by the electrical current adjacent the curvilinear outer edge 116. For these reasons, among others, the fuse portion 24 of the busbar fuse 16 may begin melting adjacent to the U-shaped edge 114 (e.g., at an earlier time than melting adjacent to the curvilinear outer edge 116). In one embodiment, the electrical paths 108 may generally begin to melt in a controlled, ordered arrangement starting from the U-shaped edge 114 and working toward the curvilinear outer edge 116.

It should be noted that, in another embodiment, the U-shaped edge 114 may include some other suitable shape, such as a straight edge, a V-shaped edge, or the like. In the illustrated embodiment, the U-shaped edge 114 may function to offset the electrical path 108 adjacent to the U-shaped edge 114 from contact points or regions 118, 120 of the busbar fuse 16. For example, the first portion 62 of the busbar fuse 16 includes the first contact region 118 configured to contact an electrochemical cell terminal, and the second portion 64 of the busbar fuse 16 includes the second contact region 120 configured to contact another electrochemical cell terminal. Line 122 is tangential to tops of the contact regions 118, 120 and line 124 is tangential to bottoms of the contact regions 118, 120. The U-shaped edge 114 of the fuse portion 24 of the busbar fuse 16 is offset from a space 126 defined between the lines 122, 124. As described above, offsetting the fuse portion 24 and corresponding features (e.g., the U-shaped edge 114, the openings 66, the electrical paths 108, and the curvilinear outer edge 116) may increase distances traveled by the electric current through the busbar fuse 16 (e.g., along the curvilinear outer edge 116), thus causing an increase in resistance along the increased distances.

Further, the U-shaped edge 114 (or another suitably shaped edge) may define a gap 128 between the first edge 107 of the first portion 62 of the busbar fuse 16 and the second edge 110 of the second portion 64 of the busbar fuse 16. The gap 128 may be sized to promote melting of the fuse portion 24 in response to an electric current approaching or reaching arc fault conditions. For example, the gap 128 may be between 0.5 millimeters and 2 millimeters. In general, the above-described offset features may be selected to cause an electric current threshold that, when exceeded by the electric current through the busbar fuse 16, causes the electrical paths 108 of the fuse portion 24 of the busbar fuse 16 to melt in a particular sequence. FIG. 7 is a front view of an embodiment of the busbar fuse 16 of the battery module 14 of FIG. 2, the busbar fuse 16 having melted at the fuse portion 24 after having received an electric current exceeding the electric current threshold (e.g., after an arc fault condition).

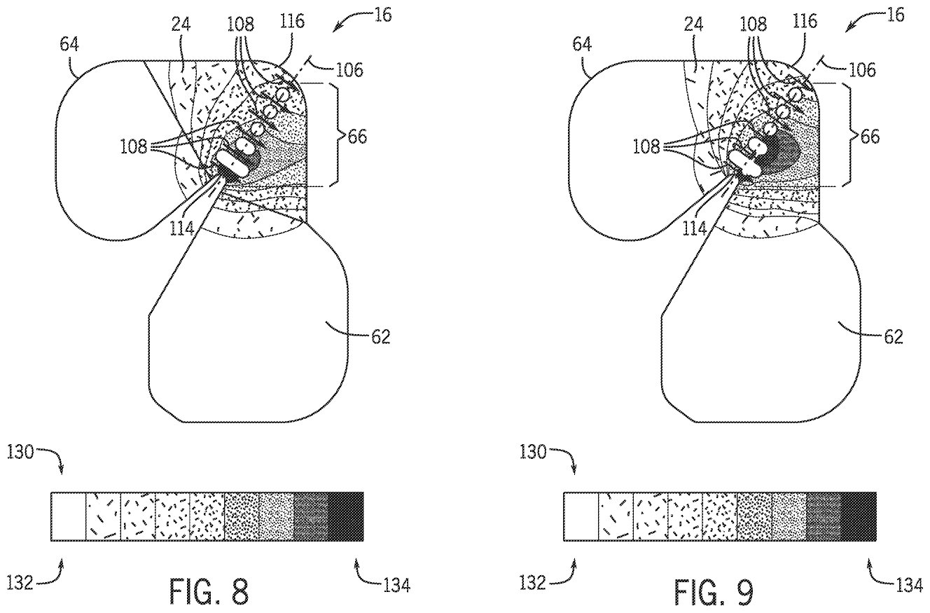

Although the fuse portion 24 of the busbar fuse 16 may begin to melt adjacent the U-shaped edge 114 illustrated in FIG. 6 and melting may progress toward the curvilinear edge 116 illustrated in FIG. 6, a progression of melting may not be entirely linear between the U-shaped edge 114 and the curvilinear outer edge 116. FIGS. 8-11, described in detail below, illustrate the busbar fuse 16 as it begins to melt in response to a relatively high electric current and temperature over time. Temperature gradients are depicted on the busbar fuse 16 in each of FIGS. 8-11. Further, a legend 130 is provided in each of FIGS. 8-11 depicting the temperature gradients ranging from relatively cold 132 to relatively hot 134.

FIG. 8 is a front view of an embodiment of the busbar fuse 16 of the battery module 14 of FIG. 2, where the busbar fuse 16 receives an electric current exceeding an electric current threshold. As illustrated in FIG. 8, a temperature is higher in the fuse portion 24 than in the first portion 62 and the second portion 64 of the busbar fuse 16 (e.g., due to a thickness of the fuse portion 24 relative to thicknesses of the first portion 62 and the second portion 64). Within the fuse portion 24, the temperature is highest adjacent to the U-shaped edge 114 (e.g., due to the current density being the highest adjacent to the U-shaped edge 114).

Along the fuse axis 106, the temperature (and current density) is lowest adjacent the curvilinear outer edge 116. As previously described, the current density is higher adjacent the U-shaped edge 114 than adjacent the curvilinear outer edge 116 because a distance traveled by the electric current adjacent the U-shaped edge 114 is less than a distance traveled by the electric current adjacent the curvilinear outer edge 116. Thus, the resistance faced by the electric current adjacent the U-shaped edge 114 is, in total, lower than the resistance faced by the electric current adjacent the curvilinear outer edge 116. Areas of the fuse portion 24 having a higher current density are heated to a greater extent than areas of the fuse portion 24 having a lower current density.

As the electric current continues to heat the fuse portion 24 of the busbar fuse 16, the fuse portion 24 may begin to melt. FIG. 9 is a front view of the busbar fuse 16 of FIG. 8, where the busbar fuse 16 is beginning to melt in response to receiving the electric current exceeding the electric current threshold. Portions of the fuse portion 24 along the fuse axis 106 and relatively close to the U-shaped edge 114 may begin to melt first. As can be seen by comparing FIGS. 8 and 9, the two electrical paths 108 closest to the U-shaped edge 114 may begin to melt first, while the four electrical paths 108 closest to the curvilinear outer edge 116 may initially remain intact.

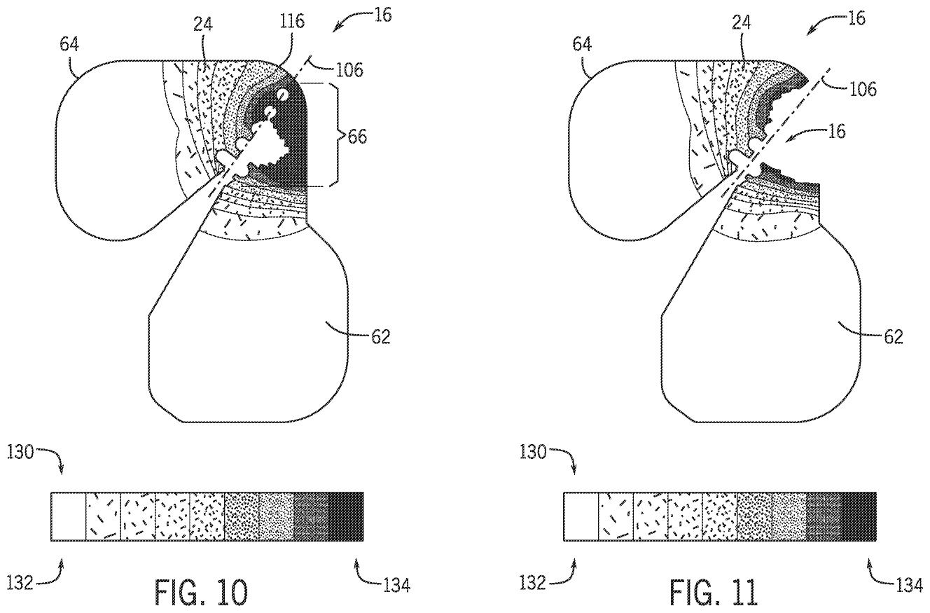

As various ones of the electrical paths 108 extending across the fuse axis 106 begin to melt, current density and/or temperature spikes across the fuse axis 106 may shift. FIGS. 10 and 11 illustrate further melting progression across the fuse axis 106 extending through the openings 66 in the fuse portion 24. As can be seen in FIG. 11, the fuse portion 24 melts entirely across the fuse axis 106, generating a gap 140 in the fuse portion 24 that disconnects the first portion 62 of the busbar fuse 16 from the second portion 64 of the busbar fuse 16. In general, the busbar fuse 16 is configured such that, upon melting of the fuse portion 24 across the fuse axis 106, the gap 140 in the fuse portion 24 is large enough to block or prevent further arc current.

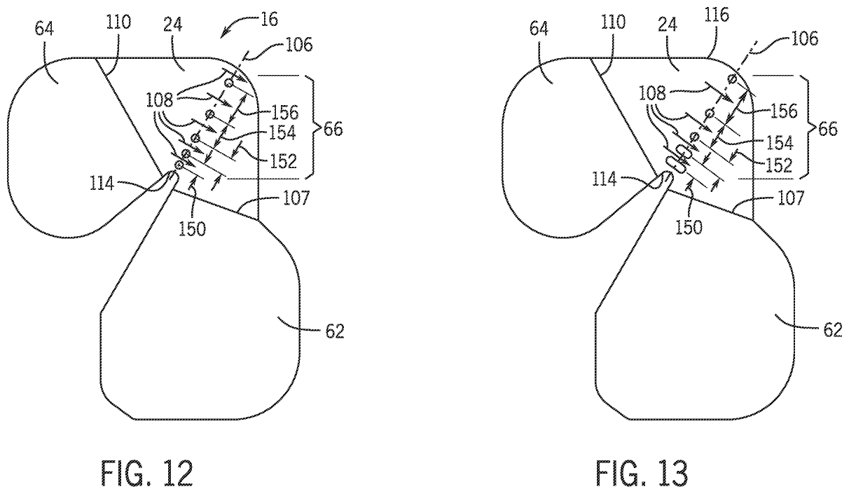

FIGS. 12-14 are front views of embodiments of the busbar fuse 16 having various arrangements of the openings 66 and corresponding electrical paths 108 defined by the openings 66. For example, FIG. 12 is a front view of an embodiment the busbar fuse 16 of the battery module 14 of FIG. 2, where the busbar fuse 16 includes a fuse portion 24 in which all the openings 66 are circular. Further, the openings 66 are spaced from each other at different distances such that the corresponding electrical paths 108 include different widths. For example, the fuse portion 24 in FIG. 9 includes a first distance 150 between a first pair of the openings 66 (e.g., along the fuse axis 106), a second distance 152 between a second pair of the openings 66 (e.g., along the fuse axis 106), a third distance 154 between a third pair of the openings 66 (e.g., along the fuse axis 106), and a fourth distance 156 between a fourth pair of the openings 66 (e.g., along the fuse axis 106). The fourth distance 156 is greater than the third distance 154, the third distance 154 is greater than the second distance 152, and the second distance 152 is greater than the first distance 150. That is, the distances 150, 152, 154, 156 between pairs of the openings 66 increases from the U-shaped edge 114 to the curvilinear outer edge 116. This may cause the current density adjacent to the U-shaped edge 114 to be greater than that adjacent to the curvilinear outer edge 116 because the first distance 150 is least among the other distances (152, 154, 156), thus providing the least resistance.

FIG. 13 is a front view of an embodiment of the busbar fuse 16 of the battery module 14 of FIG. 2, where the busbar fuse 16 includes the fuse portion 24 in which some of the openings 66 are slot-shaped and some of the openings 66 are circular. For example, the two openings 66 closes to the U-shaped edge 114 of the fuse portion 24 are slot-shaped, and the other openings 66 are circular. As is the case in the busbar fuse 16 illustrated in FIG. 12, the busbar fuse 16 in FIG. 13 includes the varying distances 150, 152, 154, 156 between pairs of the openings 66 in the fuse portion 24, which define widths of the respective electrical paths 108 extending across the fuse portion 24. As such, this may cause the current density adjacent to the U-shaped edge 114 to be greater than that adjacent to the curvilinear outer edge 116 because the first distance 150 is least among the other distances (152, 154, 156), thus providing the least resistance.

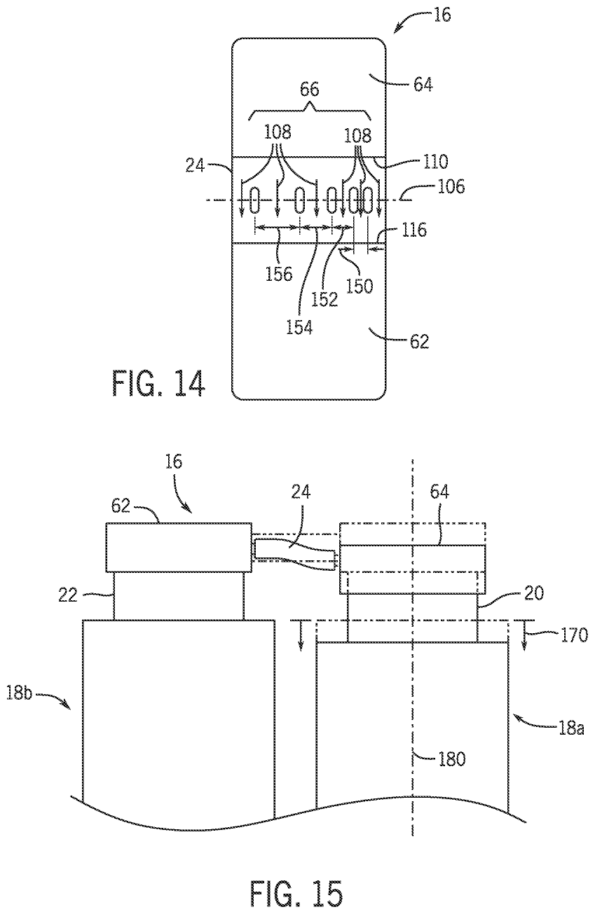

FIG. 14 is a front view of an embodiment of the busbar fuse 16 of the battery module 14 of FIG. 2, where the busbar fuse 16 includes the fuse portion 24 in which all the openings 66 are slot-shaped. As is the case in the busbar fuse 16 illustrated in FIGS. 12 and 13, the busbar fuse 16 in FIG. 13 includes the varying distances 150, 152, 154, 156 between pairs of the openings 66 in the fuse portion 24, which define widths of the respective electrical paths 108 extending across the fuse portion 24. Further, in FIG. 14, the fuse portion 24 is not offset from the first portion 62 and the second portion 64 of the busbar fuse 16. Because the first distance 150 is least among the other distances (152, 154, 156), the current density traversing the first distance 150 may be the greater than that traversing the other distances.

It should be noted that, in general, the various characteristics illustrated in the various embodiments of the busbar fuse 16 in FIGS. 1-14 can be combined in any suitable manner. The characteristics, such as the shape(s) of the openings 66, the distance(s) between the openings 66 (and corresponding widths of the respective electrical paths 108 defined between pairs of the openings 66), the offset features of the fuse portion 24, the relative thicknesses between the fuse portion 24, the first portion 62, and the second portion 64, shapes of the various edges 107, 110, 114, 116, etc., may be selected to correspond to a desired electric current threshold of the busbar fuse 16 at which portions of the fuse portion 24 melt to electrically isolate the first portion 62 of the busbar fuse 16 from the second portion 64 of the busbar fuse 16.

FIG. 15 is a schematic side view of an embodiment of a busbar fuse pre-stressing technique for the battery module 14 of FIG. 2 based on translation of a first electrochemical cell 18a relative to a second electrochemical cell 18b along a height direction 170. In the illustrated embodiment, the first terminal 20 of the first electrochemical cell 18a is coupled to the second portion 64 of the busbar fuse 16, and the second terminal 22 of the second electrochemical cell 18b is coupled to the first portion 62 of the busbar fuse 16. The fuse portion 24 of the busbar fuse 16 extends from the first portion 62 to the second portion 64 of the busbar fuse 16. After coupling the busbar fuse 16 to the first terminal 20 and the second terminal 22, the first electrochemical cell 18a is translated along the height direction 170 (e.g., along a longitudinal axis 180 of the first electrochemical cell 18a) relative to the second electrochemical cell 18b. The translation of the first electrochemical cell 18a along the height direction 170 may cause a mechanical pre-stressing of the fuse portion 24 of the busbar fuse 16, as shown. The mechanical pre-stressing of the fuse portion 24 of the busbar fuse 16 may enable the fuse portion 24 to melt in response to a lower electric current than an embodiment in which the fuse portion 24 is not pre-stressed. That is, the mechanical pre-stressing of the fuse portion 24 may reduce the electric current threshold associated with melting of the fuse portion 24.

FIG. 16 is a schematic side view of an embodiment of a busbar fuse pre-stressing technique for the battery module 14 of FIG. 2 based on translation of the first electrochemical cell 18a relative to the second electrochemical cell 18b along a width direction 172. In the illustrated embodiment, the first terminal 20 of the first electrochemical cell 18a is coupled to the second portion 64 of the busbar fuse 16, and the second terminal 22 of the second electrochemical cell 18b is coupled to the first portion 62 of the busbar fuse 16. The fuse portion 24 of the busbar fuse 16 extends from the first portion 62 to the second portion 64 of the busbar fuse 16. After coupling the busbar fuse 16 to the first terminal 20 and the second terminal 22, the first electrochemical cell 18a is translated along the width direction 172 (e.g., along a lateral axis 182 of the first electrochemical cell 18a) relative to (e.g., pulled away from) the second electrochemical cell 18b. The translation of the first electrochemical cell 18a along the width direction 172 may cause a mechanical pre-stressing of the fuse portion 24 of the busbar fuse 16. The mechanical pre-stressing of the fuse portion 24 of the busbar fuse 16 may enable the fuse portion 24 to melt in response to a lower electric current than an embodiment in which the fuse portion 24 is not pre-stressed. That is, the mechanical pre-stressing of the fuse portion 24 may reduce the electric current threshold associated with melting of the fuse portion 24.

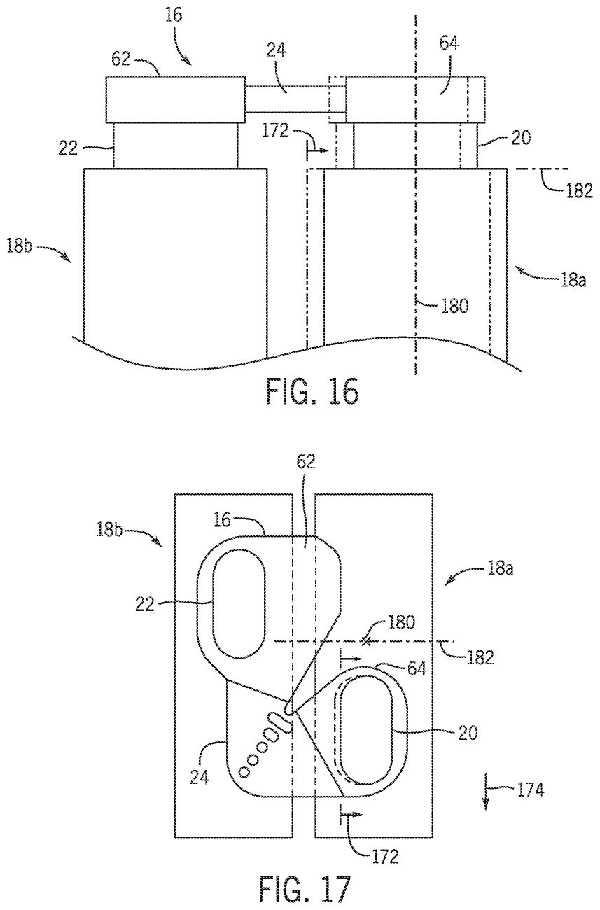

FIG. 17 is a schematic side view of an embodiment of a busbar fuse pre-stressing technique for the battery module 14 of FIG. 2 based on translation of the first terminal 20 of the first electrochemical cell 18a relative to the second terminal 22 of the second electrochemical cell 18b along the width direction 172. For example, while FIG. 16 illustrates translation of the entire first electrochemical cell 18a along the width direction 172, FIG. 17 illustrates translation of only the first terminal 20 of the first electrochemical cell 18a along the width direction 172. The translation of the first terminal 20 of the first electrochemical cell 18a along the width direction 172 (e.g., along the lateral axis 182 of the first electrochemical cell 18a) may cause a mechanical pre-stressing of the fuse portion 24 of the busbar fuse 16. The mechanical pre-stressing of the fuse portion 24 of the busbar fuse 16 may enable the fuse portion 24 to melt in response to a lower electric current than an embodiment in which the fuse portion 24 is not pre-stressed. That is, the mechanical pre-stressing of the fuse portion 24 may reduce the electric current threshold associated with melting of the fuse portion 24. It should be noted that the first terminal 20 or the entire first electrochemical cell 18a may additionally or alternatively be translated along the length direction 174 illustrated in FIG. 17 to cause a mechanical pre-stressing of the fuse portion 24 of the busbar fuse 16.

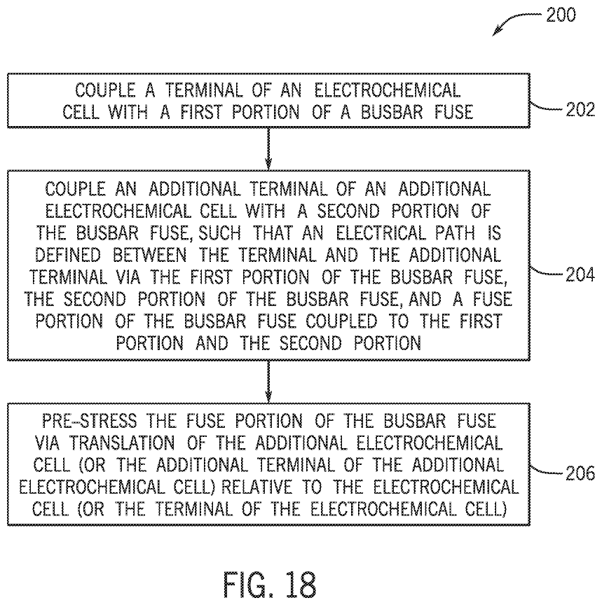

FIG. 18 is a process flow diagram illustrating an embodiment of a method 200 of manufacturing the battery module 14 of FIG. 2. The method 200 includes coupling (block 202) a first portion 62 of a busbar fuse 16 with a terminal 22 of an electrochemical cell 18b. The first portion 62 of the busbar fuse 16 may be coupled to the terminal 22 of the electrochemical cell 18b via welding, rivets, fasteners, or another coupling technique.

The method 200 also includes coupling (block 204) a second portion 64 of the busbar fuse 16 with an additional terminal 20 of an additional electrochemical cell 18a, such that an electrical path is defined between the terminals 20, 22 via the first portion 62 of the busbar fuse 16, the second portion 64 of the busbar fuse 16, and a fuse portion 24 of the busbar fuse 16 coupled to the first portion 62 and the second portion 64. The second portion 64 of the busbar fuse 16 may be coupled to the terminal 20 of the electrochemical cell 18a via welding, rivets, fasteners, or another coupling technique.

The method 200 also includes pre-stressing (block 206) the fuse portion 24 of the busbar fuse 16 via translation of the additional electrochemical cell 18a (or the additional terminal 20 of the additional electrochemical cell 18a) relative to the electrochemical cell 18b (or the terminal 22 of the electrochemical cell 18b). For example, any of the pre-stressing techniques illustrated in FIGS. 15-17 and/or described above with respect to FIGS. 15-17 may be employed at block 206.

Technical effects of the present disclosure include enabling safe assembly and operation of a battery module without a dedicated fuse separate from a busbar, thereby reducing a size and improving an energy density of a battery module relative to traditional embodiments. Further, technical effects of the present disclosure include facilitating arc fault interruption throughout various portions of the battery module without substantially increasing a size (and substantially reducing an energy density) of the battery module. Further, negative effects associated with arc fault conditions may be limited to the busbar fuse, thereby reducing or negating negative effects to other components of the battery module, such as the electrochemical cells and terminals thereof. Further still, technical effects of the present disclosure include reducing an amount of personal protective equipment (PPE) required for personnel assembling the battery module.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A busbar for a battery module, comprising:
a first portion configured to be coupled to a first terminal of a first battery cell;
a second portion configured to be coupled to a second terminal of a second battery cell; and
a fuse portion extending between the first portion and the second portion, the fuse portion comprising a plurality of openings extending through the fuse portion, the plurality of openings defining a plurality of electrical paths between the first portion and the second portion.

2. The busbar of claim 1, wherein:
the first portion comprises a first thickness;
the second portion comprises a second thickness; and
the fuse portion comprises a third thickness that is less than the first thickness and the second thickness.

3. The busbar of claim 2, wherein the first thickness is greater than the second thickness.

4. The busbar of claim 2, wherein the first thickness is equal to the second thickness.

5. The busbar of claim 1, wherein the plurality of openings comprises a circular opening and a slot-shaped opening.

6. The busbar of claim 1, wherein the plurality of openings is arranged in a line defining a fuse axis.

7. The busbar of claim 6, wherein the first portion comprises a first edge coupled to the fuse portion, the first edge extends at a first non-90 degree angle relative to the fuse axis, the second portion comprises a second edge coupled to the fuse portion, and the second edge extends at a second non-90 degree angle relative to the fuse axis.

8. The busbar of claim 1, wherein the first portion comprises a first edge coupled to the fuse portion, the second portion comprises a second edge coupled to the fuse portion, and the fuse portion comprises a U-shaped edge extending from the first edge of the first portion to the second edge of the second portion.

9. The busbar of claim 1, wherein the fuse portion comprises:
a first curvilinear edge extending between the first portion of the busbar and the second portion of the busbar, wherein a first electrical path between the first portion of the busbar and the second portion of the busbar extends adjacent to the first curvilinear edge, and the first electrical path is shorter than each electrical path of the plurality of electrical paths; and
a second curvilinear edge extending between the first portion of the busbar and the second portion of the busbar, wherein a second electrical path between the first portion of the busbar and the second portion of the busbar extends adjacent to the second curvilinear edge, and the second electrical path is longer than the first electrical path and each electrical path of the plurality of electrical paths.

10. The busbar of claim 9, wherein the plurality of openings comprises:
a slot-shaped opening disposed adjacent to the first electrical path such that the first electrical path extends between the first curvilinear edge and the slot-shaped opening; and
a circular opening disposed adjacent to the second electrical path such that the second electrical path extends between the second curvilinear edge and the circular opening.

11. The busbar of claim 1, wherein each of the plurality of electrical paths has a respective electrical resistance, and wherein each respective electrical resistance is different than the other respective electrical resistances.

12. The busbar of claim 11, wherein the fuse portion comprises a first side and a second side opposing the first side, the plurality of electrical paths extends between the first side and the second side, and the respective electrical resistances of the plurality of electrical paths increase from the first side to the second side.

13. The busbar of claim 1, wherein a first electrical path of the plurality of electrical paths comprises a first length and a second electrical path of the plurality of electrical paths comprises a second length that is greater than the first length, such that, in response to an electric current through the busbar, the first electrical path includes a greater current density than the second electrical path.

14. A battery module, comprising:
a first electrochemical cell having a first terminal;
a second electrochemical cell having a second terminal; and
a busbar comprising:
a first portion coupled to the first terminal of the first electrochemical cell;
a second portion coupled to the second terminal of the second electrochemical cell; and
a zipper fuse extending between the first portion and the second portion.

15. The battery module of claim 14, wherein the first portion of the busbar comprises a first thickness, the second portion of the busbar comprises a second thickness, and the zipper fuse of the busbar comprises a third thickness that is less than the first thickness and less than the second thickness.

16. The battery module of claim 15, wherein the third thickness is approximately 5-50% of the first thickness and 5-50% of the second thickness.

17. The battery module of claim 14, wherein the zipper fuse comprises a plurality of electrical paths defined by a plurality of openings extending through the zipper fuse.

18. A method of manufacturing a battery module, comprising:
coupling a first portion of a busbar with a first terminal of a first electrochemical cell;
coupling a second portion of the busbar with a second terminal of a second electrochemical cell, such that an electrical path is defined between the first terminal and the second terminal by the first portion of the busbar, the second portion of the busbar, and a fuse portion of the busbar extending between the first portion and the second portion.

19. The method of claim 18, comprising translating the first electrochemical cell relative to the second electrochemical cell to cause a mechanical stressing of the fuse portion of the busbar.

20. The method of claim 19, wherein translating the first electrochemical cell relative to the second electrochemical cell to cause the mechanical stressing of the fuse portion of the busbar comprises translating the first electrochemical cell relative to the second electrochemical cell along a width direction of the battery module.

21. The method of claim 19, wherein translating the first electrochemical cell relative to the second electrochemical cell to cause the mechanical stressing of the fuse portion of the busbar comprises horizontally translating the first electrochemical cell relative to the second electrochemical cell along a height direction of the battery module.

22. A busbar for a battery module, comprising:
a first portion configured to be coupled to a first terminal of a first electrochemical cell;
a second portion configured to be coupled to a second terminal of a second electrochemical cell; and
a fuse portion extending between the first portion and the second portion, the fuse portion comprising a zipper fuse having a plurality of electrical paths configured to generate a corresponding plurality of electrical resistances, each electrical resistance of the plurality of electrical resistances being different than the other electrical resistances of the plurality of electrical resistances.

23. The busbar of claim 22, wherein the fuse portion comprises a first side and a second side opposing the first side, the plurality of electrical paths extends between the first side and the second side, and the corresponding plurality of resistances of the plurality of electrical paths increase from the first side to the second side.
